(19) United States
(12) Patent Application Publication
(10) Pub. No.: US 2025/0145271 A1
(43) Pub. Date: May 8, 2025

(54) Aircraft with Hybrid Power Supply and Unobstructed Cabin Door Access

(71) Applicant: Textron Aviation Inc., Wichita, KS (US)

(72) Inventors: Gonzalo Eduardo Mendoza, Wichita, KS (US); Corey Wailes Hagemeister, Wichita, KS (US); Steven Michael Klausmeyer, Wichita, KS (US)

(21) Appl. No.: 18/934,165

(22) Filed: Oct. 31, 2024

Related U.S. Application Data
(60) Provisional application No. 63/595,542, filed on Nov. 2, 2023.

(51) Int. Cl. B64C 1/14; B64D 27/33; B64D 27/355; B64D 27/357

(52) U.S. Cl. CPC B64C 1/1423; B64D 27/33; B64D 27/355; B64D 27/357

(57) ABSTRACT

An aircraft having unobstructed cabin door access includes a hybrid power drive with a combustion engine connected to an electricity generating machine. Components of the hybrid power drive are positioned throughout the aircraft to provide a weight distribution having an aft bias. The aircraft further includes a forward swept wing and a cabin door positioned forward of the forward swept wing, such that access into a fuselage of the aircraft via the cabin door is unobstructed by the forward swept wing.

### CROSS-REFERENCE TO RELATED APPLICATIONS

This application claims the benefit of U.S. Provisional Patent Application No. 63/595,542, filed Nov. 2, 2023, the entire contents thereof are herein incorporated by reference.

### FIELD

The present invention relates generally to aircraft design, specifically to the design of an aircraft that provides relatively unobstructed access to cabin doors from the exterior of the aircraft by using a hybrid power supply combined with moderately forward swept wings.

### BACKGROUND

Single engine piston airplane cabin ergonomics are influenced heavily by the relatively large mass of the powerplant. Installation of the powerplant in the front of the airplane is often most practical as it provides minimally disrupted airflow through the propeller disk, allows for natural takeoff rotation without excessively long (and therefore heavier) landing gear legs, and enables carriage of fuel within most of the volume of the wing with reasonable center of gravity variations. The challenge for high performance small passenger airplanes with forward mounted engines, however, comes from the natural placement of the wing, which, owing to balance issues, ends up being placed fairly far forward. On a high wing mounted configuration, this results in a fairly upright windshield, which increases drag and reduces visibility. On the more desirable low wing installation, the wing ends up impinging in the cabin and often results in entry/exit door access requiring a climb over the wing. This is problematic for individuals with limited mobility, creates a hazard in wet conditions, results in unsightly and drag contributing anti-slip coatings and, in general, detracts from the high-end experience expected from an expensive vehicle.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In certain embodiments, an aircraft having unobstructed cabin door access includes: a hybrid power drive including a combustion engine connected to an electricity generating machine; a weight distribution of the hybrid power drive including an aft bias; a forward swept wing; and a cabin door positioned forward of the forward swept wing such that access into a fuselage of the aircraft via the cabin door is unobstructed by the forward swept wing.

In certain embodiments, an aircraft having unobstructed cabin door access includes: a hybrid power drive including one or more engines, one or more generators, one or more batteries, and one or more electric motors, wherein components of the hybrid power drive are positioned in the aircraft to provide a weight distribution having an aft bias; a forward swept wing; and a cabin door positioned forward of the forward swept wing such that access into a fuselage of the aircraft via the cabin door is unobstructed by the forward swept wing.

### BRIEF DESCRIPTION OF THE DRAWINGS

FIG. 1 is a partial internal perspective view of an aircraft having a hybrid power drive and unobstructed cabin door access in accordance with an exemplary embodiment of the present invention;

FIG. 2 is a side partial cross section view of a second embodiment of an aircraft having a hybrid power drive and unobstructed cabin door access;

FIG. 3 is a side partial cross section view of a third embodiment of an aircraft having a hybrid power drive and unobstructed cabin door access;

FIG. 4 is a side partial cross section view of a fourth embodiment of an aircraft having a hybrid power drive and unobstructed cabin door access;

FIG. 5 is a perspective view of the aircraft of FIG. 1;

FIG. 6 is side view of the aircraft of FIG. 1;

FIG. 7 is a perspective view of the aircraft of FIG. 2;

FIG. 8 is side view of the aircraft of FIG. 2;

FIG. 9 is a perspective view of a fifth embodiment of an aircraft having a hybrid power drive and unobstructed cabin door access;

FIG. 10 is a side view of a sixth embodiment of an aircraft having a hybrid power drive and unobstructed cabin door access;

FIG. 11 is a perspective view of the aircraft of FIG. 10;

FIG. 12 is a side view of a seventh embodiment of an aircraft having a hybrid power drive and unobstructed cabin door access;

FIG. 13 is a side view of an eighth embodiment of an aircraft having a hybrid power drive and unobstructed cabin door access;

FIG. 14 is a perspective view of the aircraft of FIG. 13;

FIG. 15 is a side view of a ninth embodiment of an aircraft having a hydrogen fuel cell—electric power unit and unobstructed cabin door access;

FIG. 16A is a front perspective view of a tenth embodiment of an aircraft having a hybrid power drive and unobstructed cabin door access; and

FIG. 16B is a bottom perspective view of the aircraft of FIG. 16A.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” “leftwardly,” “upper,” and “lower” will refer to the installed position of the item to which the reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

Embodiments disclosed herein relate to an aircraft that provides relatively unobstructed access to cabin doors from the exterior of the aircraft and utilizes a hybrid power supply coupled with a moderately forward swept wing configuration. The disclosed aircraft embodiments leverage a hybrid power system that includes a combustion engine (e.g., piston, rotary, turbine, or generally any fuel burning engine) connected to an electricity generating machine, both of which could be installed in the aft portion of the aircraft while preserving a tractor propeller, driven by an electric motor or stack of electric motors, in the front of the aircraft. Alternatively, the engine, generator, and electric motor may be installed in the front (a compact series or parallel hybrid powerplant), with batteries placed in the aft fuselage. A full battery-electric airplane, with some or all of the batteries installed in the aft portion of the aircraft in lieu of the combustion engine, may be configured as described. Additionally, a hydrogen fuel cell-electric powerplant, with similar electric motor configuration, aft hydrogen tanks, and fuel cells distributed between the aft section and forward motor compartment in lieu of or in addition to batteries may also be configured as described. The various embodiments take advantage of the distributive nature of batteries, electric motors, fuel cells, and generators, to bias the weight rearwards such that a mildly forward swept wing arrangement can provide an acceptable aerodynamic balance while an unobstructed cabin section remains available for the placement of cabin access doors. In one configuration, the empennage is configured as a “V-tail,” providing a distinctive look to the aircraft, a potential benefit in drag, as well as needed dihedral for lateral static stability. Other empennage configurations, particularly a T-tail, may also work as part of the concept. The V-tail may be advantageous for aesthetic, mechanical, or aerodynamic purposes (increase ramp appeal, allow space for exhaust vents, ballistic parachute attachments, or simply to reduce aerodynamic intersections and the number of balanced control surfaces).

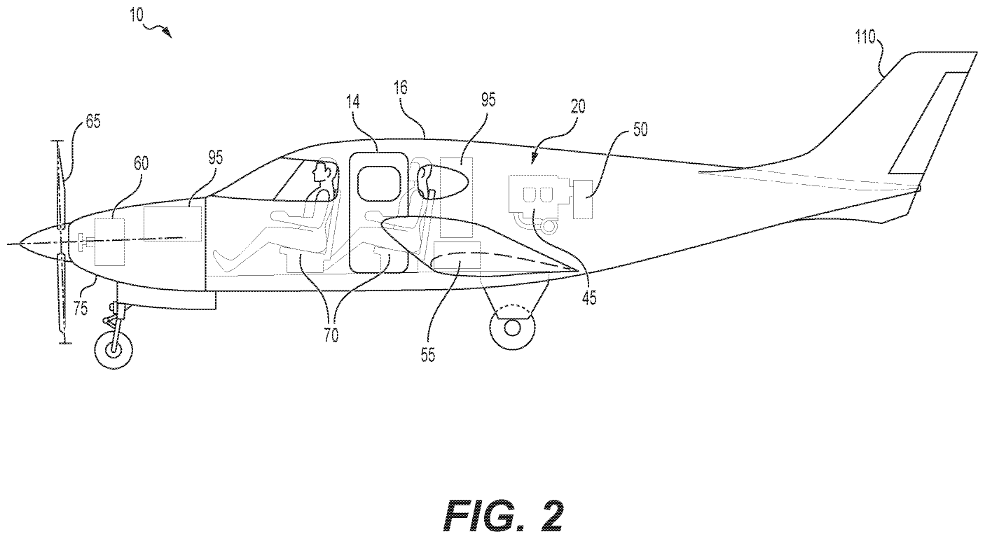

An exemplary embodiment of the invention is shown in the figures. Referring to the figures, the invention comprises an aircraft 10 having relatively unobstructed access to one or more cabin doors 14 located on a fuselage 16 of the aircraft. Unobstructed access to doors 14 is made possible by a hybrid power drive 20 that has components which may be located throughout the aircraft 10 to promote a weight distribution that works well with the aircraft's moderately forward swept wings 30. As shown in FIGS. 2-4, the hybrid power drive 20 can take different forms but generally includes a combustion engine 45, an electricity generator 50, a battery 55, and an electric motor 60.

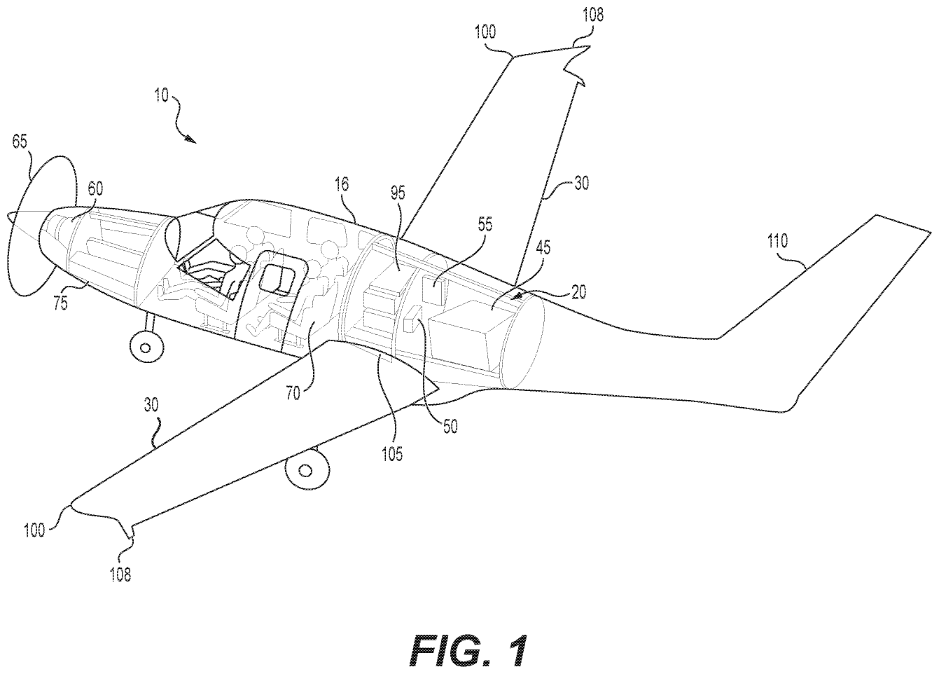

As best seen in FIGS. 1-4, aircraft 10 may include a hybrid power drive 20 for driving a propeller 65. The hybrid power drive 20 may utilize components disclosed in applicant's prior U.S. Pat. No. 10,967,981, the disclosure of which is incorporated herein by reference. In the hybrid power drive 20, the propeller 65 may be driven using an electric motor 60. The electric motor 60 may receive electrical power created by an electricity generator 50 located on board aircraft 10 or by the battery 55 or some combination thereof. More specifically, the hybrid power drive 20 may incorporate a combustion engine 45 which receives fuel (e.g., gasoline or other petrol) from a fuel tank, vaporizes the fuel with air, combusts the mixture, and then exhausts the combusted products through an exit duct extending from the engine 45 to a port formed in the aircraft skin to release into the environment. Engine 45 may take a number of different forms including a piston engine, gas turbine, rotary, or other kind of engine. Thus, the invention should not be limited to any sort of engine unless otherwise stated.

Engine 45 may drive an electricity generator 50 using a mechanical connection. Generator 50 is used to convert the mechanical energy transferred through the mechanical connection of the engine 45 into electrical energy which can be used to drive propeller 65 (or propellers). Various types of generators 50 may be used include a Permanent Magnet Synchronous Machine (PMSM) generator, a Hybrid Excitation Synchronous Machine (HESM) generator, a Field Excited Synchronous Generator (FESG), an Induction Generator (IG), or other numerous other kinds of alternating current (AC) or direct current (DC) devices/generators capable of converting mechanical energy into electricity. The power generated by the generator 50 may also be used to charge battery 55. In one embodiment, the power rating for the generator 50 may be 375 horsepower. As shown in FIG. 15, engine 45 may take the form of a hydrogen fuel cell-electric powerplant 112 having one or more aft hydrogen tanks 115 with fuel cells 120 distributed throughout the aircraft including in the aft portion of the fuselage 16 aft of the passenger seats and/or in the nose 75 of the aircraft such as the forward motor compartment.

The power available from battery 55 may be converted into AC power (by a converter or inverter) to drive electric motor 60, which is electrically connected to battery 55. In one embodiment, the electric motor 60 may be rated at approximately 375 to 500 horsepower, depending on application and performance requirements of aircraft 10. In installations where more than one electric motor 60 provides power to a single propeller 65, the individual motors may be sized to provide additional emergency time limited power, for example, using a pair of 250 hp motors with capability to provide 300 to 350 horsepower in an emergency. Although an exemplary embodiment of the invention utilizes AC motor for the purpose of driving propeller 65, it should also be noted that a DC motor could also be used. This would involve the use of different electrical equipment (e.g., a converter/inverter would not be necessary).

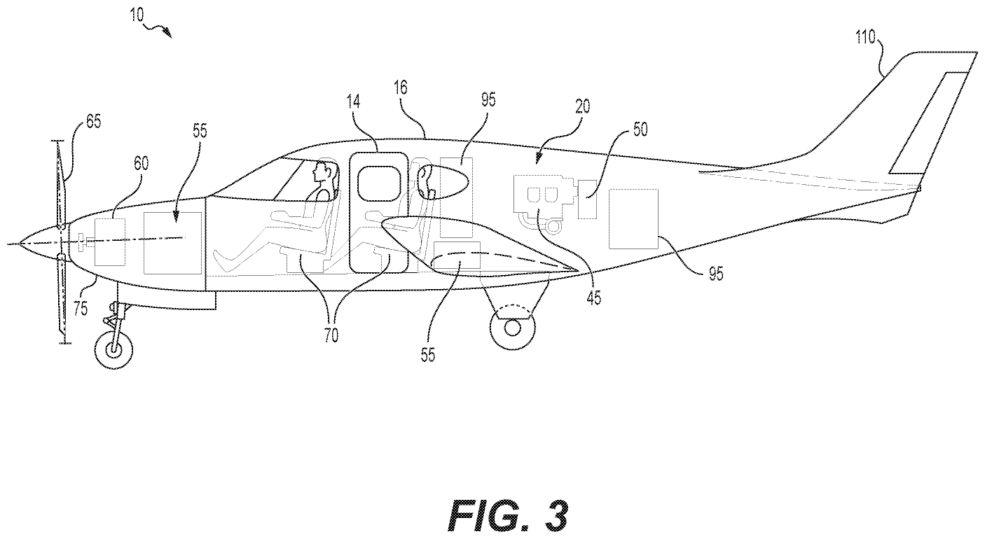

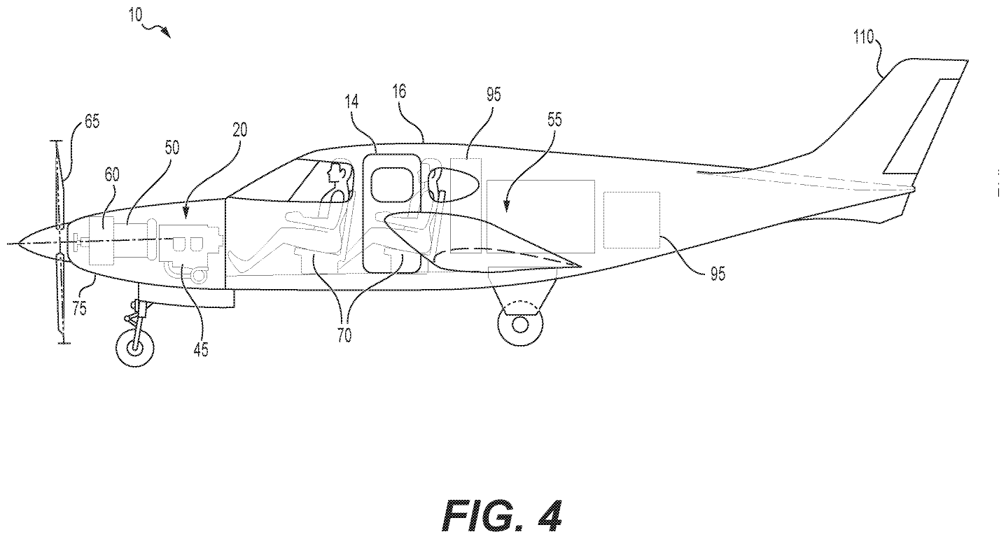

A benefit of using a hybrid power drive 20 is the ability to place the various components of the system throughout the aircraft 10 to achieve a desired weight distribution. As shown in FIGS. 1-4, there are several arrangements that may work to accommodate a plurality of occupants and a desirable weight distribution. As shown in FIG. 2, engine 45, generator 50 and battery 55 may be located in the aft area of the fuselage 16 of the aircraft 10 behind the passenger and pilot seats 70, while the electric motor 60 may be in the forward portion or nose 75 of the aircraft. FIG. 3 shows an alternative embodiment where engine 45 and generator 50 may be located in the aft area of the fuselage 16 of the aircraft 10, while the battery 55 and electric motor 60 may be in the nose 75 of the aircraft. FIG. 4 shows another alternative embodiment where battery 55 may be located in the aft area of the fuselage 16 of the aircraft 10, while the engine 45, generator 50 and electric motor 60 may be in the nose 75 of the aircraft. In addition to creating a desirable weight distribution, these various configurations also create space for luggage 95 and other storage. While the foregoing illustrates some of the embodiments of the invention, other embodiments and configurations for the components of the hybrid power drive 20 are foreseen.

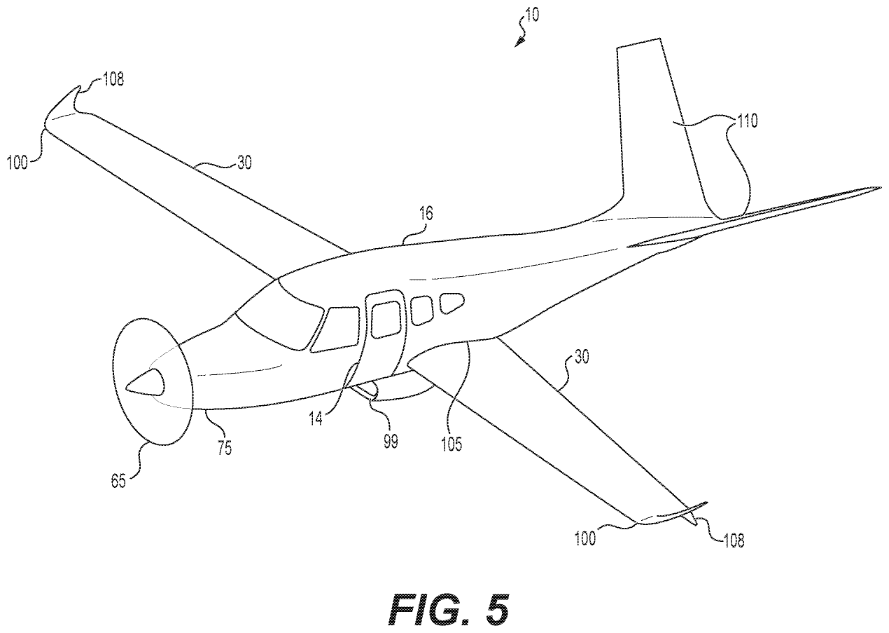

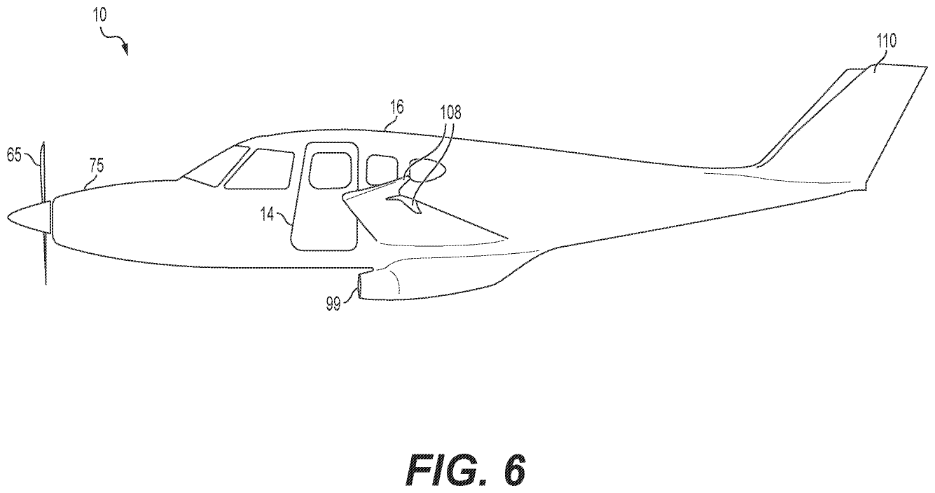

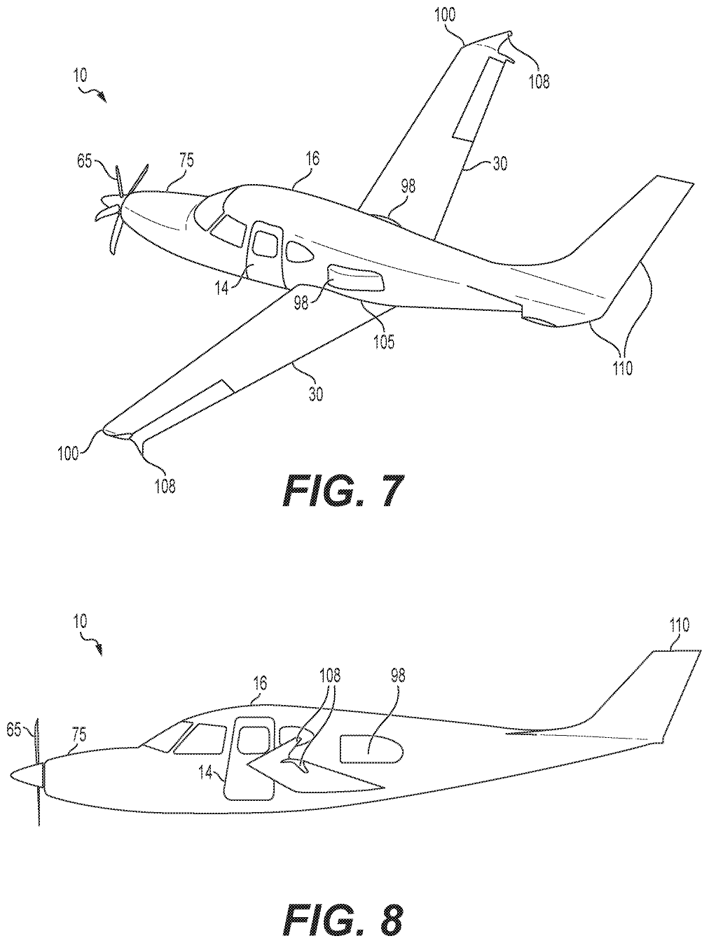

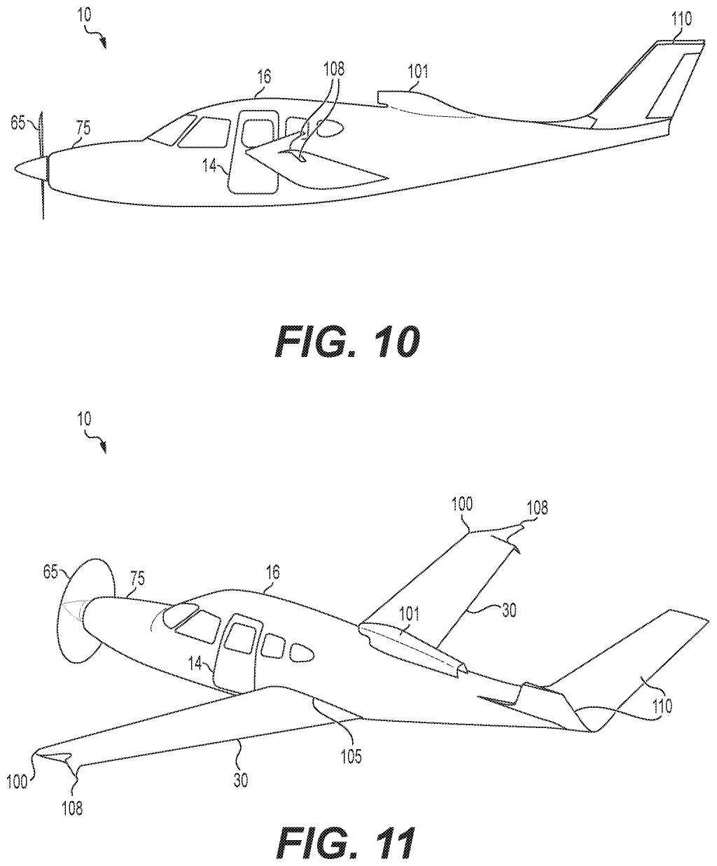

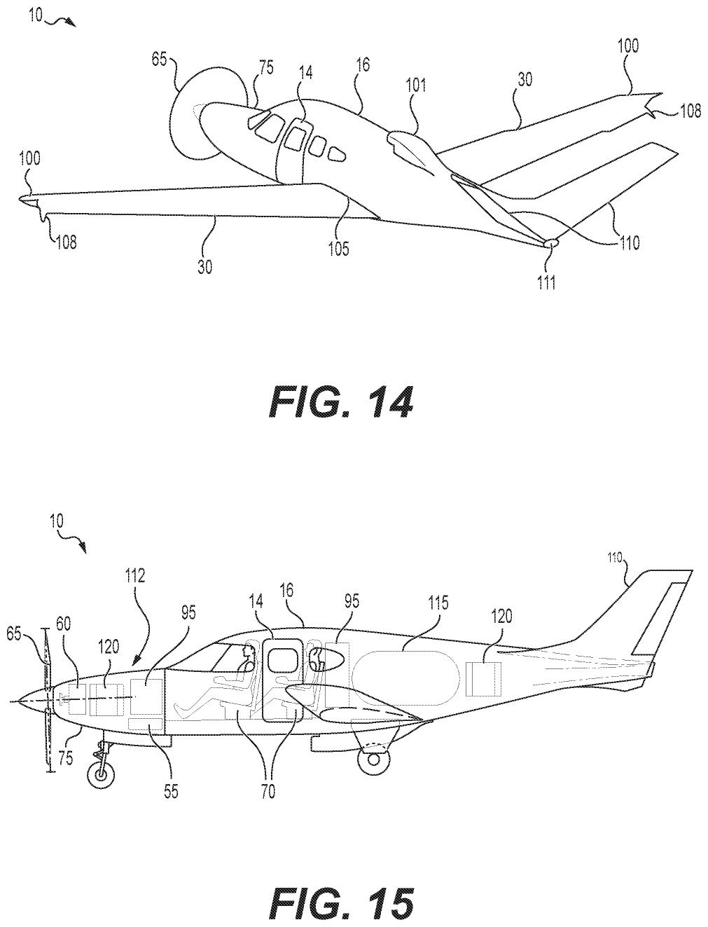

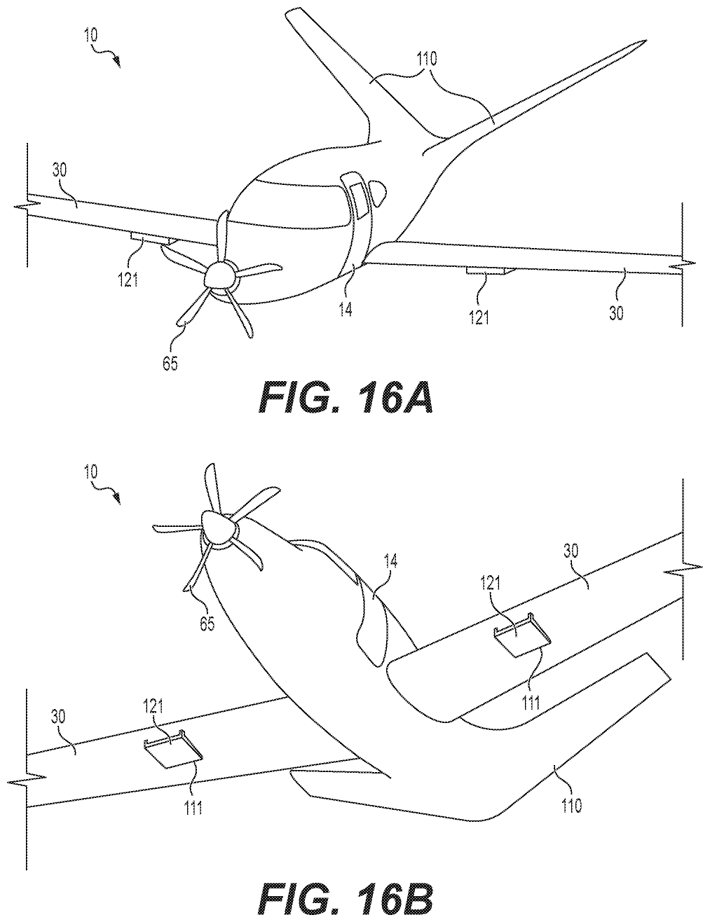

As best seen in FIGS. 5-8 and 10-14, aircraft 10 may include cooling and/or engine inlets to supply portions of the hybrid power drive 20. For example, engine 45, generator 50 and battery 55 may give off significant amounts of heat when in use. Accordingly, if any of those components (or any other components that give off heat) are placed in areas without direct airflow from outside of the aircraft, there is a risk of overheating. In addition, engine 45 may require intake air to operate. FIGS. 7 and 8 show one or more cooling and/or engine inlets 98 located on the side of the fuselage 16 and FIGS. 5 and 6 show a cooling inlet 99 on the underside or belly of the fuselage 16. FIGS. 10-14 show a cooling and/or engine inlet 101 located on top of the fuselage 16. FIG. 16A and FIG. 16B depict an embodiment having a heat exchanger 121 mounted to an underside of each wing 30. The heat exchangers 121 are for example engine radiators having a forward-facing inlet for receiving air flow and aft-facing exit 111. Other locations are possible as well depending on the specific configuration of the hybrid power drive 20 components in the aircraft. Typically, there will be some type of ducting from the inlets to direct outside air to the component or components that require cooling or intake air.

Another benefit of using a hybrid power drive 20 is the ability provide power to the electric motor 60 from one or more batteries 55 in the event of fuel system failure or other mechanical malfunction of the engine 45 or generator 50. A battery 55 may provide power to drive the propeller 65 until aircraft 10 moves to a safe altitude and speed. Alternative embodiments using multiple generators and motors may also minimize opportunities for total power loss. A fully redundant system of two generators 50 and two electric motors 60 may provide multi-engine like dependability with the simplicity of handling of a single propeller aircraft configuration. In one embodiment, the aircraft 10 power drive comprises one or more batteries 55 and one or more electric motors 60. The weight distribution of such a power drive may comprise batteries 55 located aft of the passenger seats in an aft portion of the fuselage 16; and the engine 45 and additional batteries 55 and power electronics located forward of the pilot seats in the nose 75 portion of the aircraft.

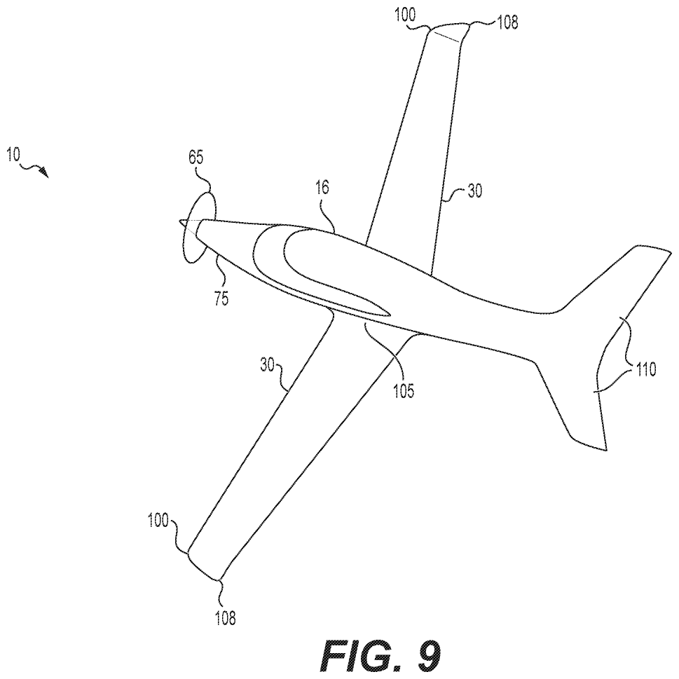

As shown in FIGS. 1 and 5-9, aircraft 10 may also include moderately forward swept wings 30. The forward swept wing arrangement helps provide aerodynamic balance while allowing an unobstructed space on the fuselage 16 for one or more cabin doors 14. By having unobstructed cabin door 14 access, pilots and passengers may not have to climb on a wing to enter the cabin. Each wing 30 may be swept forward such that wingtip 100 at the distal end of the wing is set forward toward the front of aircraft 10 with respect to the of the base 105 of the wing attached to the fuselage 16. Each wing 30 may be wider at base 105 and then taper inward as the wing extends towards wingtip 100. The longitudinal center line of wing 30 running from the center point of base 105 to the center point of wingtip 100 may generally angle forward toward the front of the aircraft 10 as a result of the forward swept orientation of wing 30. As best seen in FIGS. 5-9, wingtip 100 may include winglets 108 with vertical or angled members extending generally upwardly and/or downwardly. In the embodiments shown in FIGS. 5-8, the winglets 108 are examples of “tandem split divergent winglets” as best described in U.S. Patent Application Publication No. 2023/0406484 entitled Tandem Split Divergent Winglet, and as shown in U.S. Design Patent Nos. D1,026,788 and D1,026,789, both entitled Winglet, the disclosures of which are hereby incorporated by reference in their entirety.

Aircraft 10 may also include a V-shaped tail or empennage 110. A V-shaped tail 110 can provide a distinctive look to the aircraft (see FIGS. 5, 7 and 9), a potential benefit in drag, as well as needed dihedral for lateral static stability. A V-shaped tail, however, may also increase the natural dihedral of the aircraft, often resulting in the need to reduce wing dihedral (with the corresponding challenge in wing tip to ground clearance and fuel migration) or accept reduced dynamic “Dutch roll” stability. The forward swept wing 30 configuration helps minimize that effect as it reduces the dihedral effect of the airplane, thus balancing the impact of the V-tail and allowing for geometric dihedral to be preserved on the wing. The forward swept wing configuration also has inherent advantages in tip stall resistance, reducing the need for stall control devices that generally decrease aerodynamic performance. While a V-shaped tail 110 is a suitable empennage for the present invention, other empennage configurations, such as a T-tail, may also be used.

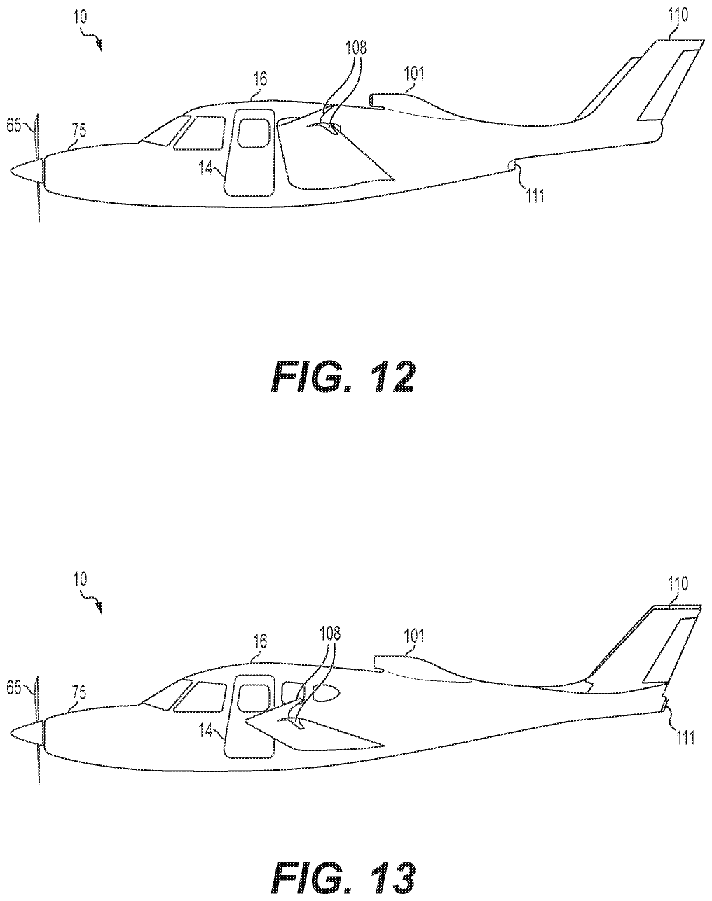

Aircraft 10 may also include a turbogenerator and corresponding turbogenerator exhaust ports 111 located on the underside of the aircraft and/or proximate tail 110. Exhaust ports 111 are best seen in FIGS. 12-14. There may be one or more exhaust ports 111 depending on the configuration of aircraft 10 and location of the turbogenerator.

In embodiments, exhaust ports 111 are configured to move away heat from cooling radiators. In certain embodiments, exhaust ports 111 to both move away heat from cooling radiators in addition to exhausting engine fumes. For example, single or dual exhaust ports 111 may carry just engine exhaust in the case of a turbine-turbogenerator, both engine fumes and radiator heat in the case of an externally cooled turbogenerator, such as a piston engine, or only radiator heat in the case of an electric or fuel-cell powered configuration.

In use, hybrid power drive 20 in combination with the forward swept wing 30 configuration allows the aircraft 10 to be balanced in a way that permits an unobstructed access to one or more cabin doors 14 to avoid climbing over the wing for access. The distribution of the hybrid power drive 20 components—where the relatively heavy elements may be placed in the aft of the cabin—allows for the wing base 105 to be pulled back sufficiently to create an unobstructed cabin length ahead of it for placement of a door or doors 14. A forward swept wing configuration allows for the aerodynamic center and tail arm to be correctly placed for stability and control without excessively lengthening the tail cone of the aircraft.

As an example, in one embodiment, the hybrid power drive 20 in combination with the forward swept wing 30 configuration may be used for an aircraft 10 having a 5,000 lb takeoff weight range. In that scenario, aircraft 10 may hold 4-5 occupants and travel at approximately 220-250 mph for 600 miles in “cabin class” comfort. Such an aircraft 10 may have a wingspan and length in the order of 40 ft and 30 ft, respectively, though larger or smaller configurations may also be viable. The design may be configured with forward wing sweep angles of approximately 5 to 20 degrees, depending on the powerplant configuration details and desired cabin length.

It is to be understood that while certain forms of the present invention have been illustrated and described herein, it is not to be limited to the specific forms or arrangement of parts described and shown.

1. An aircraft having unobstructed cabin door access, the aircraft comprising:
a hybrid power drive comprising a combustion engine connected to an electricity generating machine;
a weight distribution of the hybrid power drive comprising an aft bias;
a forward swept wing; and
a cabin door positioned forward of the forward swept wing such that access into a fuselage of the aircraft via the cabin door is unobstructed by the forward swept wing.

2. The aircraft of claim 1 comprising a V-tail empennage.

3. The aircraft of claim 1, wherein components of the hybrid power drive comprise one or more engines, one or more generators, one or more batteries, and one or more electric motors.

4. The aircraft of claim 1, wherein components of the hybrid power drive comprise one or more batteries and one or more electric motors.

5. The aircraft of claim 1, wherein components of the hybrid power drive comprise one or more hydrogen fuel cell module(s).

6. The aircraft of claim 3, wherein the weight distribution of the hybrid power drive comprises:
the engine(s), the generator(s), and the battery(ies) being located aft of passenger seats in an aft portion of the fuselage; and
the electric motor(s) being located forward of pilot seats in a nose portion of the aircraft.

7. The aircraft of claim 3, wherein the weight distribution of the hybrid power drive comprises:
the engine(s) and the generator(s) being located aft of passenger seats in an aft portion of the fuselage; and
the electric motor(s) and the battery(ies) being located forward of pilot seats in a nose portion of the aircraft.

8. The aircraft of claim 3, wherein the weight distribution of the hybrid power drive comprises:
the battery(ies) being located aft of passenger seats in an aft portion of the fuselage; and
the engine(s), the generator(s), and the electric motor(s) being located forward of pilot seats in a nose portion of the aircraft.

9. The aircraft of claim 4, wherein the weight distribution of the electric power drive comprises:
a battery located aft of passenger seats in an aft portion of the fuselage; and
the electric motor(s) and additional batteries and power electronics located forward of pilot seats in a nose portion of the aircraft.

10. The aircraft of claim 5, wherein the weight distribution of the hydrogen fuel cell power drive comprises:
a hydrogen fuel tank, power batteries, and hydrogen fuel cell modules located aft of passenger seats in an aft portion of the fuselage; and
one or more electric motors and additional batteries or fuel cell modules and power electronics located forward of pilot seats in a nose portion of the aircraft.

11. The aircraft of claim 1 comprising an inlet disposed on a side of the fuselage.

12. The aircraft of claim 1 comprising an inlet disposed on an underside of the fuselage.

13. The aircraft of claim 1 comprising an inlet on top of the fuselage.

14. The aircraft of claim 1 comprising single or dual aft underbody exhaust arrangements for exhausting turbogenerator fumes.

15. The aircraft of claim 1 comprising single or dual aft underbody exhaust ports for releasing heat from a radiator.

16. The aircraft of claim 1 comprising an aft central outlet for exhausting one or more of a turbogenerator exhaust or a cooling radiator outflow.

17. An aircraft having unobstructed cabin door access, the aircraft comprising:
a hybrid power drive comprising one or more engines, one or more generators, one or more batteries, and one or more electric motors, wherein components of the hybrid power drive are positioned throughout the aircraft to provide a weight distribution having an aft bias;
a forward swept wing; and
a cabin door positioned forward of the forward swept wing such that access into a fuselage of the aircraft via the cabin door is unobstructed by the forward swept wing.

18. The aircraft of claim 17, wherein the weight distribution of the hybrid power drive comprises:
the engine(s), the generator(s), and the battery(ies) being located aft of passenger seats in an aft portion of the fuselage; and
the electric motor(s) being located forward of pilot seats in a nose portion of the aircraft.

19. The aircraft of claim 17, wherein the weight distribution of the hybrid power drive comprises:
the engine(s) and the generator(s) being located aft of passenger seats in an aft portion of the fuselage; and
the electric motor(s) and the battery(ies) being located forward of pilot seats in a nose portion of the aircraft.

20. The aircraft of claim 17, wherein the weight distribution of the hybrid power drive comprises:
the battery(ies) being located aft of passenger seats in an aft portion of the fuselage; and
the engine(s), the generator(s), and the electric motor(s) being located forward of pilot seats in a nose portion of the aircraft.
